(19) United States
(12) Patent Application Publication
(10) Pub. No.: US 2022/0230575 A1
(43) Pub. Date: Jul. 21, 2022

(54) TRANSFORMING BACKGROUND COLOR OF DISPLAYED DOCUMENTS TO INCREASE LIFETIME OF OLED DISPLAY

(71) Applicant: Dell Products L.P., Round Rock, TX (US)

(72) Inventors: Tze Fung CHUNG, Singapore (SG); Tiak Hooy SIM, Singapore (SG)

(73) Assignee: Dell Products L.P., Round Rock, TX (US)

(21) Appl. No.: 17/152,195

(22) Filed: Jan. 19, 2021

(51) Int. Cl. G09G 3/20; G09G 3/3208; G09G 5/10

(52) U.S. Cl. CPC G09G 3/2003; G09G 3/3208; G09G 5/10; G09G 2320/0686; G09G 2320/043; G09G 2320/066; G09G 2320/0673; G09G 2320/062; G09G 2320/0666

(57) ABSTRACT

A display device includes a display panel comprising an array of pixels and a display controller that generates second pixel data corresponding to first pixel data received from a host. The display controller is configured to perform background modification operations including identifying a document window, a window associated with an application program displaying document output. If the pixels in the document window satisfy one or more conditions, pixel data for one or more background pixels in the document window may be changed. Background pixels may be associated with a first color or gray level and background modification may change the color or gray level of background pixels. The display device may be an OLED display device and background modification may change white pixels representing the background of a displayed document to a gray shade to reduce the OLED current and extend OLED display lifetime.

### TECHNICAL FIELD

The present disclosure relates to electronic display devices and, more specifically, organic light emitting diode (OLED) display devices.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems frequently include a host system coupled to one or more display devices, which convey visually perceptible information such as text, graphics, images, and video to a user. Typically, the host system includes a dedicated graphics module with a graphics processing unit that generates pixel data formatted in compliance with any of a number of display interface standards including, as non-limiting examples Digital Visual Interface (DVI), High Density Multimedia Interface (HDMI), and DisplayPort (DP), among others. The display device typically includes a display controller that processes pixel data received from the host to generate electrical signals that illuminate the individual pixels of the display panel.

The pixel data received from the host typically includes color data indicative of a color assigned to the pixel, which may be conveyed in accordance with any of one or more defined color models and/or color spaces. A red-blue-green (RGB) color model, as an example, constructs each color as a weighted combination of red, blue, and green components typically referred to as primaries. An N-bit RGB color model conveys pixel color via three N-bit values, with the first value indicating a luminous intensity for the red primary, the second value indicating luminous intensity for a blue primary, and the third value indicating a luminous intensity for the green primary. An 8-bit RGB color model, to illustrate, can specify any of 256 luminous intensities for each primary. The color white is typically indicated with a maximum luminous intensity for each primary while the color black is typically indicated with a minimum value for each primary. Thus, the brightest color of white in an 8-bit RGB model has the RGB values (255, 255, 255) while a true black color has the RGB values (0, 0, 0).

Display controllers include resources to perform various operations on pixel data received from a host. As an example, a display controller may perform color transformation to convert pixel data derived in accordance with a first color space model to a second color space model for various reasons, such as matching the pixel data to color generating characteristics of the display device.

Liquid crystal display (LCD) devices and organic light omitting diode (OLED) display devices are two of the most pervasive and commercially significant display device technologies. An OLED display device includes a light-emissive film of organic compound positioned between a pair of electrodes. The organic film produces light in response to electrical current, referred to herein as OLED current, driven between the electrodes.

The luminous intensity of light produced by the organic compound varies as a function of the OLED current, with higher OLED current producing brighter light and lower OLED current producing less bright light. While its light emissive film enables OLED display devices to omit back lighting required in LCD devices, produce true black pixels not possible with back lit LCD devices, and achieve a higher contrast ratio than LCD devices, the expected lifespan of the organic film may be lower than the expected lifetime of competing display technologies and this disparity may be increase when brighter content is displayed. In some cases, the end of life for OLED display devices manifests itself with the appearance of an image persistence or “image sticking” issue.

### SUMMARY

In accordance with the teachings of the present disclosure, decreased life expectancy and other challenges associated with displaying bright content on an OLED display device are reduced or eliminated by one or more systems and methods disclosed herein.

In accordance with disclosed embodiments, an information handling system includes a display device and a host information handling resource, sometimes referred to herein simply as a host. The host includes a central processing unit (CPU) and a graphics module, such as a graphics card, that includes a graphics processing unit (GPU). The host CPU, among other functions, executes application programs that generate display information including, as examples, video, still images, text, an so forth. Each application program may be associated with one or more operating system windows which are often visible on the display device. Generally, the GPU processes display information generated by the CPU and generates pixel data, sometimes referred to herein as first pixel data or native pixel date. The first pixel data may include pixel data formatted in accordance with any one or more native formats supported by the GPU.

The display device may include a display controller and a display panel comprising a pixel array including a plurality of pixels arranged in rows and columns. The display controller is configured to receive a stream of display content from the host and process the stream to extract first pixel data, perform local processing of the first pixel data to generate second pixel data, and store the second pixel data as a sequence of image frames. The display controller includes timing control logic configured to generate precisely timed control signals in accordance with the image frames and one or more clock signals generated by a crystal oscillator or another suitable resource.

Pixel processing performed by the display controller may include processing to convert the resolution of the first pixel data to a different resolution format, perform gamma correction and color space transformation, insert on-screen displays as needed, and so forth. In addition, in accordance with disclosed subject matter, the display controller may perform background modification processing to change the background color of content identified as document content, from a first color, typically maximum-brightness white, to a less bright or more gray shade, which may be referred to herein as the background color or background shade.

Background modification processing disclosed herein may include identifying a document window, which may refer to a subset of the pixel array associated with an application program displaying document output. The background processing may then determine whether the identified document window satisfies any of one or more background modification conditions. The background processing may respond to identifying a document window and determining that the document window satisfies one or more conditions by changing the color of one or more background pixels in the document window from white or another color to background gray. In at least some exemplary embodiments, the display device is an OLED display device and background modification increases results in less OLED current for an appreciable percentage of the pixel array and this decrease may result in longer lifetime.

To facilitate background modification, some embodiments may beneficially leverage functionality provided in an application program or utility that the host has access to . As an example, the identification of application windows that constitute document windows may include communication with a display management application that maintains window information indicative of the pixel coordinates associated with each open or active application window. The display management application may also maintain information indicative of the type of application associated with each active application. In some embodiments, this application type information may include information indicative of applications that document application, i.e., applications that likely to produce display output that constitutes document output. This information may beneficially facilitate background modification as disclosed herein by providing information that may enable the background modification operations to determine the pixels eligible for background modification.

In some embodiments, the display controller may include a scaler resource, which may be implemented as a scaler chip, e.g., a semiconductor integrated circuit, or as a set of software instructions, or as a combination of hardware and software. In addition to being configured to perform pixel format scaling, color processing, and OSD operations, the scaler module may include or support subzone features for collective monitoring and managing of subzones of the pixel array. In these embodiments, the background modification operations may include accessing the scaler's subzone information and the identification of a document window may include identifying pixel coordinates of a document application and mapping the pixel coordinates to one or more pixel array subzones defined by the scaler resource. The scaler resource may be capable of performing image histograms for each subzone and, in these embodiments, background modification operations may include determining whether to modify background pixels in a pixel array subzone based on an image histogram of the subzone.

After identifying a pixel that qualifies for background modification, embodiments may modify the color of the pixel and, more specifically, the luminous intensity. Background modification may include changing the color of a background pixel from a first color that is associated with high OLED current to a second color that is associated with lower OLED current. In at least one embodiment, the first color is white, which has a maximum gray level, a maximum luminous intensity, and a maximum associated OLED current, and the second color is a shade of gray, which has a lower gray level, a lower luminous intensity and a lower OLED current.

Background modification may require an initial determination of the background color, which is the color that will be assigned to applicable background pixels. In at least some embodiments, determining the background color includes determining an optimum gray level of the background color. The optimum gray level may correspond to the lowest gray level satisfying a minimum contrast ratio requirement. To determine the optimum gray level, information indicative of at least two points of a gamma curve characteristic of the display panel may be accessed. In the context of a document consisting of text and background, the contrast ratio refers to the luminous intensity of the background color prior to any background modification, which is frequently but not necessarily white, divided by the luminous intensity of the text color, which is frequently although not necessarily black. In the particular case of an OLED display the device, because the actual luminous intensity of a black pixel is zero or substantially zero, a non-zero luminous intensity value may be designated as the black level luminosity for use in conjunction with the minimum contrast ratio parameter.

Technical advantages of the present disclosure may be apparent to those of ordinary skill in the art in view of the following specification, claims, and drawings.

### BRIEF DESCRIPTION OF THE DRAWINGS

A more complete understanding of disclosed subject matter and advantages thereof may be acquired by referring to the following description taken in conjunction with the accompanying drawings, in which like reference numbers indicate like features, and wherein:

FIG. 1 illustrates a block diagram of a disclosed information handling system;

FIG. 2 illustrates a display of an original document;

FIG. 3 illustrates a display of the original document of FIG. 2 after performing disclosed background modification operations;

FIG. 4 illustrates a flow diagram of a background modification method;

FIG. 5 illustrates a plot of an exemplary gamma curve for a display device;

FIG. 6 illustrates plots of various tone mapping curves supported by a display device;

FIG. 7 illustrates an exemplary user interface for a display manager application;

FIG. 8 illustrates a second exemplary user interface for a display manager application; and

FIG. 9 illustrates an exemplary background modification user interface for a display manager application.

### DETAILED DESCRIPTION

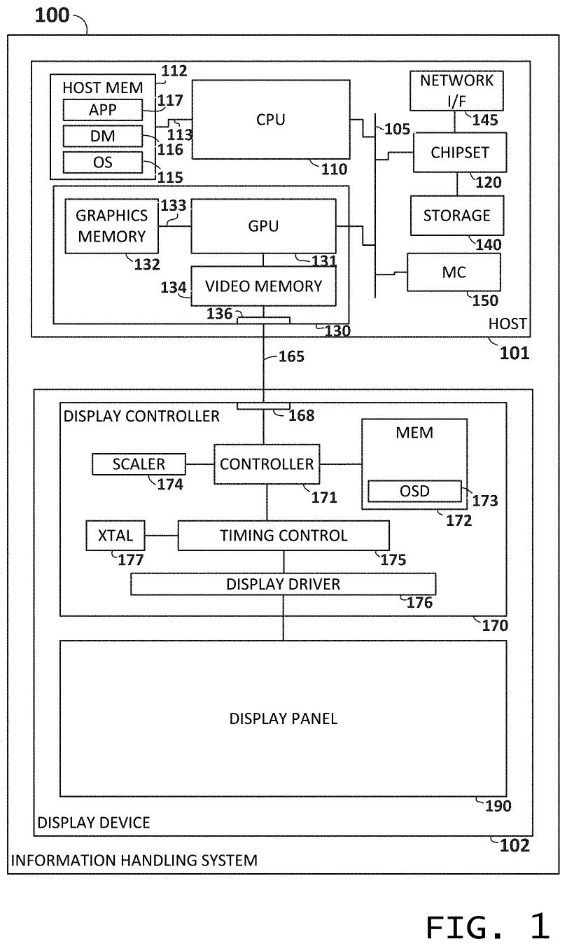

Exemplary embodiments and their advantages are best understood by reference to FIGS. 1-9, wherein like numbers are used to indicate like and corresponding parts. For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network data storage device, or any other suitable device and may vary in size, shape, performance, functionality, and price. The information handling system may include memory, one or more information handling resources such as a CPU or another form of control logic implemented in hardware, software, or a combination of both. Additional components of the information handling system may include one or more data storage devices, one or more communications ports for communicating with external devices as well as various input and output (I/O) devices, such as a keyboard, a mouse, and a video display. The information handling system may also include one or more buses operable to transmit communication between the various hardware components.

In this disclosure, the term “information handling resource” may broadly refer to any component system, device or apparatus of an information handling system, including without limitation processors, buses, memories, input-output devices and/or interfaces, storage resources, network interfaces, motherboards, electro-mechanical devices (e.g., fans), displays, and power supplies.

Referring now to the drawings, FIG. 1 illustrates a block diagram of an information handling system 100 in accordance with background modification features disclosed herein. The information handling system 100 illustrated in FIG. 1 includes a host 101 and a display device 102.

It will be readily appreciated by those of ordinary skill in the field of information handling system design and operation that host 101 is configured to boot one or more instances of an operating system (not depicted in FIG. 1) and execute one or more applications programs (not depicted in FIG. 1) that generate display information, including, as non-limiting examples, video content, still image content, graphics content, and alphanumeric text documents including word processing documents, spreadsheet documents, email and text messages documents, presentation documents, and so forth.

Display information may then be processed by a resource such as GPU 131 to obtain pixel data, which may then be encoded into a stream of video content suitable for delivery to a display controller. Pixel data may include pixel-specific color and brightness information for each pixel in a sequence of image frames. Pixel data may be sent to a display controller for additional processing and, ultimately, presentation to the display panel.

As disclosed herein, display device 102 includes or supports a background modification feature configured to reduce the gray level of some of the pixels within one or more specific types of displayed content. In at least one embodiment, display device 102 is configured to identify or monitor certain application programs or certain types of applications programs, generally referred to herein as document applications. Document applications tend to produce output consisting entirely or largely of alphanumeric text and background. Alphanumeric text is typically displayed in black font, i.e., gray level=0, and background, which is typically displayed in white, e.g., gray level=255 for an 8-bit, RGB color space. Background modification as disclosed herein may identify active windows associated with one or more document applications, monitor and/or analyze the displayed content generated by the identified document application(s), and, subject to satisfying one or more certain conditions, reduce the gray level of pixels associated with a displayed document's background. Such background pixels will typically have the maximum gray level supported by the color space and the modified pixel will have a gray level that results in considerably less OLED current while still achieving an acceptable and comfortable contrast ratio. By displaying a gray shade that draws considerably less OLED current, the background modification features disclosed herein beneficially extend the expected lifetime of an OLED display device by reducing the average, cumulative, and peak OLED current.

The host 101 illustrated in FIG. 1 includes a CPU 110 communicatively coupled to one or more other information handling resources. CPU 110 accesses and executes processor executable instructions stored in a nontransitory computer readable medium. The information handling resources illustrated in FIG. 1 may be implemented as discrete or distinct devices affixed to a mother board (not depicted) or another suitable substrate. In some embodiments, two or more of the information handling resources illustrated in FIG. 1 may be integrated within a single integrated substrate comprising silicon or another electrically suitable material. In some embodiments, features illustrated in FIG. 1 may be implemented with hardware, software, firmware, or a combination thereof. The information handling resources within host 101 may be enclosed within a common chassis or another suitable enclosure.

The information handling resources illustrated in FIG. 1 includes, in addition to CPU 110, a host memory 112, a chipset 120, a graphics resource identified in FIG. 1 as graphics module 130, a persistent storage resource identified in FIG. 1 as storage 140, a network interface 145 and a management resource identified in FIG. 1 as management controller 150.

An interconnect 105 illustrated in FIG. 1 provides communicative coupling between two or more of the illustrated information handling resources. Interconnect 105 may encompass one or more shared buses, one-or-more point to point links, or a combination thereof. Chipset 120 may include or support one or more interconnect switches for coupling interconnect 105 with one or more secondary interconnects for coupling to one or more peripheral resources including, in the illustrated configuration, network interface 145 and storage 140. In at least some embodiments, interconnect 105 includes one or more high speed, serial interconnects exemplified by a peripheral component interconnect express (PCIe) interconnect, preferably supporting a minimum of 16 gigatransactions/second.

The host memory 112 illustrated in FIG. 1 may store processor-executable instructions, sometimes referred to herein as program instructions, which may be accessed and executed by CPU 110. Host memory 112 may include program instructions corresponding to various host system functions, services, and applications. For the sake of simplicity and clarity, however, the program instructions illustrated in

FIG. 1 have been limited to operating system instructions (OS) 115, display manager instructions (DM) 116, and an application program 117 that generates display information and, in at least some instances, is a document-type application that generates document-type output suitable for background modification as disclosed herein.

The graphics module 130 illustrated in FIG. 1 includes a GPU 131, communicatively coupled to a graphics memory 132 via graphics memory interconnect 133, and a storage resource identified as video memory 134, which may function as dual-ported frame buffer storage for display device 102. FIG. 1 illustrates video memory 134 communicatively coupled between GPU 131 and a video interface port 136. Video interface port 136 may be configured to encode or otherwise process pixel data received from GPU 131 and video memory 134 and into a stream of video content or multimedia content, which is delivered to a display controller 170 by way of a video transport 165, which may correspond to or include a high definition multimedia interface (HDMI) cable, a DisplayPort cable, or another suitable video interface connection.

In some embodiments, graphics module 130 may be implemented as a video card or video board, in which any one or more of the illustrated elements of graphics module 130 are affixed to a printed circuit board configured to connect to a motherboard (not depicted) of host 101. In other embodiments, some or all of the illustrated elements of graphics module 130 may be embedded in a host system motherboard or integrated within CPU 110, chipset 120, or another one or more of the illustrated information handling resources.

The display controller 170 illustrated in FIG. 1 includes a video interface port 168 communicatively coupled to video interface port 136 of graphics module 130 via video transport 165. Video interface port 168 may be configured to receive and decode and otherwise process a video stream or multimedia stream from graphics module 130 and to provide pixel data to an information handling resource identified in FIG. 1 as controller 171.

Controller 171 may be implemented in any suitable configuration capable of performing the disclosed controller operations. As non-limiting examples, display controller 171b may be a programmable integrated circuit, an application specific integrated circuit (ASIC), a field programmable gate array (FPGA), a microcontroller unit (MCU), a CPU or other processing device. In some embodiments, display controller 250 may comprise, or be configured to execute, software and/or firmware to perform one or more of the operations noted herein.

The controller 171 illustrated in FIG. 1 is communicatively coupled to a display controller memory 172 and to a scaler resource identified in FIG. 1 as scaler 174. The display controller memory 172 includes on-screen display instructions (OSD) 173, which may be executed by controller 171 for presenting one or more on-screen displays to display device 102. On-screen displays comprise images that are superimposed on the original video content. On-screen displays may provide one or more display device user interfaces for configuring one or more display settings or characteristics.

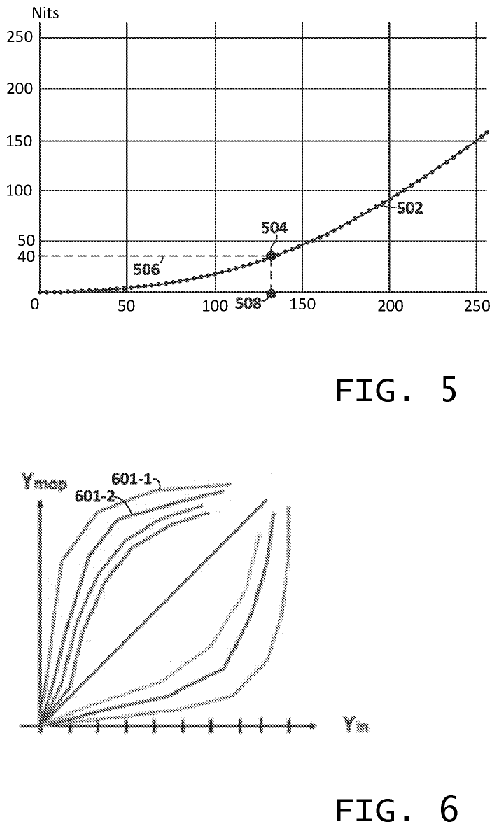

The scaler 174 illustrated in FIG. 1 may be implemented in hardware, such as a chip or semiconductor integrated circuit, in software, such as a set of executable programs instructions (not explicitly depicted in FIG. 1) stored in display controller memory 172 and executed by controller 171, or a combination of both hardware and software. Scaler 174 may perform or facilitate any of one or more video support functions. As an example, GPU 131 may generate pixel data with a transport format that differs from the pixel resolution of display device 102. In such instances, scaler 174 may be configured to convert the pixel data from one format to another. In addition, scaler 174 may be configured to perform gamma correction, color space transformation, and so forth. In some embodiments, scaler 174 may support multiple tone mapping curves 601-1, 601-2, etc., examples of which are illustrated in FIG. 6.

In some embodiments, scaler 174 may further include or support resources for collectively monitoring, managing, and analyzing portions or subzones of the display panel pixel array. At least one embodiment of scaler 174 supports 1296 subzones and includes resources for generating frequency histograms of each subzone.

Controller 171, in conjunction with scaler 174 and OSD 173, may process incoming pixel data from host 101 and provide the processed pixel data to timing control logic 175. The timing control logic 175 illustrated in FIG. 1 receives the processed pixel data from controller 171 and one or more clock signals from a clock source represented in FIG. 1 by crystal oscillator 177. Timing control logic 175 is configured to generate time-synchronized display driver input signals that cause display driver circuitry 176 to generate and deliver time-synchronized driving signals, such as low voltage differential signals (LVDS), to the display panel and thereby cause the display panel to display the display content as a sequence of image frames.

In at least one respect, the present disclosure encompasses a method of conserving, preserving, or extending

OLED display device lifetime by identifying document applications that an information handling system is executing and monitoring display output generated by the identified document applications. When document output meeting one or more conditions for background modification, hereinafter referred to simply as background modification, is detected, the background color may be modified by changing all white pixels, as an example, within the detected document output to a shade of gray referred to herein as the background color.

Background modification operations may include or require an initial determination of a suitable background color. In at least one embodiment, the background color used for background modification is a shade of gray satisfying at least two competing conditions. First, the background color must be sufficiently gray or “un-white” to produce an appreciable decrease in OLED current. Second, the background color must be bright enough to achieve sufficient contrast with the document's text and/or simple graphics. Some embodiments may employ one or more color look up tables (CLUTs), in which case, pixel data may be used to index a CLUT that associates one or more color values with a corresponding and predefined color.

In some embodiments, background modification may leverage or extend capabilities of existing resources. As non-limiting examples, disclosed embodiments of background modification operations may coordinate with scaler engine resources that enable the scaler to identify and monitor specific sub-groups of the display panel's pixels. In addition, background modification operations may access a digital signal processing (DSP) resource to perform a rapid assessment of whether an identified group of pixels satisfies one or more conditions for background modification.

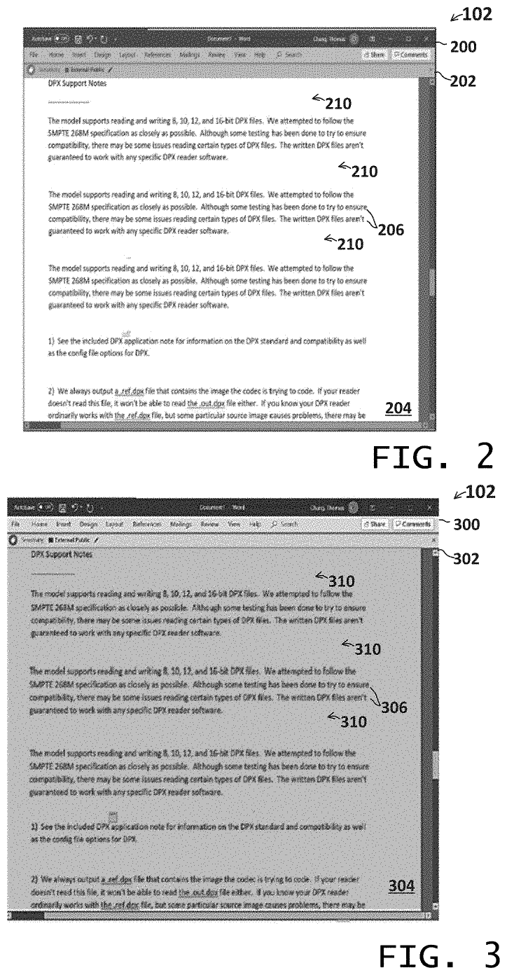

Turning now to FIG. 2 and FIG. 3, the background modification of a displayed document, in accordance with disclosed subject matter, is illustrated. FIG. 2 illustrates display device 102 displaying an image frame 200. The image frame 200 illustrated in FIG. 2 includes an application window 202 containing window content 204. Because the window content 204 corresponds to a word processing document, window content 204 may be referred to as document content 204 and application window 202 may be referred to as document window 202.

The document content 204 illustrated in FIG. 2 consists entirely or primarily of alphanumeric text 206 on a white background 210. In addition, it will be readily appreciated that, within document window 202, the ratio of white pixels or background pixels, to black pixels or text pixels, sometimes referred to herein as the background ratio, is substantially greater than 1 and may, in at least some instances, exceed a significantly higher value. In some embodiments, the background ratio of a displayed window may determine, at least in part, whether to apply background modification to document content. In at least one embodiment, a background ratio threshold of approximately 4:1 may be applied. In such embodiments, a document window in which 80% or more of the pixels are background pixels may trigger or qualify for background modification. It will be readily appreciated that the 80% value is but one example and that other threshold values may be used.

FIG. 3 illustrates displayed content 300 including a document window 302 displaying document content 304 after background modification has been performed. The document content 304 within document window 302 comprises the same alphanumeric text 206 that was contained in document content 204 depicted in FIG. 2, but the document content 304 in FIG. 3 includes a gray background 310 in lieu of the white background 210 of document content 204.

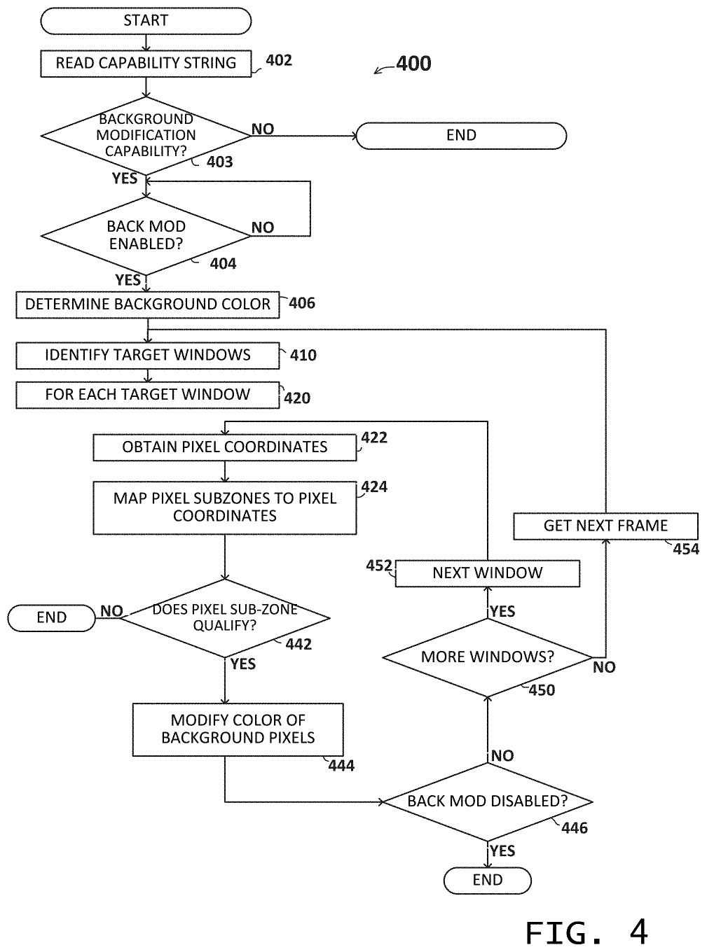

In the example illustrated in FIG. 2 and FIG. 3, display device 102 is displaying a single application window that occupies the entire display panel and the entire application window is occupied by a single displayed document. In other embodiments, not depicted, display device 102 may display multiple application windows, any one or more of which may be windows corresponding to a document application and any one or more of which may be associated with applications that are not document applications. Referring now to FIG. 4, a flow diagram illustration of a background modification method 400 for modifying the background color of a displayed document is presented. The background modification method 400 illustrated in FIG. 4 may be referred to herein as background modification method 400. It should be recognized that the particular elements and sequence of elements illustrated in FIG. 4 are exemplary and that other elements and sequences not depicted in the drawings will be readily apparent to one of ordinary skill in the field having the benefit of this disclosure. In at least some embodiments, one or more of the elements illustrated in FIG. 4 correspond to actions performed by display controller 170 (FIG. 1) while, in at least some of embodiments, elements of the illustrated method may be performed by graphics module 130 (FIG. 1), CPU 110, or another information handling resource.

The background modification method 400 illustrated in FIG. 4 begins with display controller determining whether the display device includes or supports background modification. In at least one embodiment, this determination may be made as part of a broader determination of the display device's capabilities. In FIG. 4, the determination of a display device's capabilities is represented by operation 402, in which host 101 reads a capability string of display device 102. Display devices may include one or more externally accessible registers or other types of non-volatile storage elements for storing device capability information indicative of the display device's capabilities. Capability information may be formatted in accordance with one or more device capability format standards including, as examples, the Extended Display Identification Data (EDID) and DisplayID standards from the Video Electronics Standards Association (VESA). In such embodiments, background modification capability may be conveyed via one or user-defined extensions of the applicable standard.

Upon determining (operation 403) that a display device lacks background modification capability, the background modification method 400 illustrated in FIG. 4 simply terminates. If, however, it is determined in operation 403 that a display device has background modification capability, the background modification method 400 illustrated in FIG. 4 may next determine (operation 404) whether the display device's background modification capability is enabled.

In at least some embodiments, the display manager application described with respect to FIG. 1 may be accessed or invoked to enable and disable background modification capability. If the display device's background modification capability is disabled, background modification method 400 may loop on operation 404, continuously or periodically checking on the status of the display device's background modification capability.

If the display device's background modification capability is enabled, the background modification method 400 illustrated in FIG. 4 may next determine (operation 406) an appropriate background color for displayed documents. The background color may refer to the color chosen to replace the typically white pixels within background portions of a displayed document. For OLED display device embodiments, a background color may be chosen to achieve a desirable combination of a suitably high contrast ratio and a suitable low OLED driving current. While a maximum contrast ratio is achieved when the text elements of a displayed document are rendered in black (e.g., gray level 0) and the background elements are pure white (e.g., gray level 255), the white background color draws an undesirably high OLED current, which may result in a reduction of the display device's lifetime.

In at least one embodiment, background color determination includes determining, identifying, or otherwise selecting a threshold contrast ratio (CR_{T}) such that CRM<=CR_{T} and CR_{T}<CRA, where CRM is the minimum contrast ratio required to view document output comfortably and CRA is the display device's achievable contrast ratio. The display device's CRA refers to the ratio of the display device's white luminance (WL) to the display device's black luminance (BL), where WL is the luminance of a white pixel (gray level 255) and the BL is the luminance of a black pixel (gray level 0). In mathematical terms, CRA=WL/BL. In at least one embodiment, CR_{T} is chosen to maximize the reduction in drive current associated required to display document background pixels. In any such embodiment, CR_{T}=CRM. In other embodiments, a higher value of CR_{T} may be selected to increase the readability of document output while also achieving at least some reduction in display drive current. In some embodiments, a single value of CR_{T} may be applicable to all document output while, in other embodiments, different values of CR_{T} may be associated with different document applications. As an example, a spreadsheet document containing closely spaced number fields formatted with a small font size may be assigned a higher CR_{T} than a word processing document containing double spaced text formatted with a larger font size. For the sake of clarity and brevity, this disclosure, unless indicates otherwise, describes embodiments in which a single value of CR_{T} is applicable to all application programs and that this single value of CR_{T} is equal to CRM.

In at least one embodiment, the background color, i.e., the color chosen for background modification, is a gray shade having a luminous intensity equal to BL*CR_{T}. However, it will be appreciated by those of ordinary skill in the field of display devices that, because BL is zero or substantially zero for OLED display, some non-zero value of BL must be assigned to an OLED display device before an appropriate background color can be determined. In some embodiments, the assigned value of BL is a predetermined value. For example, for purposes of comparing an OLED display device with LCD and other types of displays, a display device manufacturer may specify one or more values of a BL proxy, referred to herein as an effective BL, for a particular model of OLED display device.

In other embodiments, an effective BL may be estimated, extrapolated, interpolated, or otherwise inferred from the luminance value(s) of one or more of the display device's gray shades. In the following examples, L_{J} refers to the luminance of a gray shade pixel with a gray level of J. For example, in an RGB color model, L_{J} refers to the luminance of a pixel with RGB values of J:J:J. In at least one embodiment, the effective BL assigned to an OLED display device may be calculated as a linear or non-linear function of the luminosity of a single grade shade produced by the OLED display device. In any such embodiment, the effective BL might be assigned a value of P*(L_{J})^{M}, where 0<P<=1, M is any real number, and J is an integer 0<=J<=255 for a 24-bit RGB color space. In at least some embodiments, it may be preferable to calculate the effective BL based on the actual luminance of a dark gray shade, where “dark” may refer to a gray shade with a gray level of less than 16 or some other value. As an example, an effective BL may be calculated as 0.95 * L_{J}, where J is in the range from 1 and 16.

In still other embodiments, the effective BL assigned to an OLED display may be calculated as a linear or non-linear function of the luminance values for two or more gray shades. For example, an effective BL might be extrapolated based on gray shade luminances L_{J} and L_{K}. In this example, an extrapolated value of BL may be equal to: L_{J}−(m/L_{J}), where m=(L_{K}−L_{J})/(K−J).

It will be appreciated that the preceding examples are illustrative and are not limiting of any particular embodiment for defining the effective BL for an OLED display device.

After an effective BL has been determined for the display device, the luminous intensity of the background color may be calculated as the product of the effective BL and the threshold contrast ratio CR_{T}. As a non-limiting example, if the effective BL assigned to an OLED display device is 0.05 nits and CR_{T} is 800, then the luminance of the background color would be (0.05×800)=40 nits. The gray level for the background color may then be determined from gamma curve information for the applicable display device. FIG. 5 illustrates a gamma curve 502 for an exemplary display device. Gamma curve 502 indicates luminous intensity, in Nits, as a function of pixel gray level, which may vary from 0 to 255. A lookup table or another form of information indicative of the gamma curve 502 may be stored in memory or storage that is accessible to the display controller.

The background color gray level, i.e., the gray level corresponding to the background color may be determined from gamma curve 502. Specifically, a horizontal line 506, is drawn to intersect the y-axis at the background color luminance, which is approximately 40 Nits in the illustrated example. Horizontal line 506 intersects gamma curve 502 at point 504, referred to herein as operating point 504. The x-coordinate 508 of operating point 504 indicates the background color gray level. The background color gray level is approximately 139 in the illustrated example and accordingly, background modification as described herein may change the gray level of a background pixel such as a white pixel located within a document window of an OLED display device, from 255 to 139 when background modification is enabled. With gray level 139 as the background color gray level, the display panel drives the minimum OLED current necessary to maintain adequate contrast.

Returning now to FIG. 4, after determining the background color in operation 406, the background modification method 400 illustrated in FIG. 4 then proceeds to identify and modify one or more portions of the image frames displayed by the display device. Rather than attempting to consider and resolve every pixel within every image frame, the background modification method 400 illustrated in FIG. 4 first narrows the number of pixels eligible for background modification based on information pertaining to the one or more application program windows visible in the image frame. The background modification method 400 of FIG. 4, as an example, identifies (operation 410) target windows. Program windows associated with document applications may be referred to herein as target windows or document windows, which may be defined herein as windows associated with an application program that typically generates document-type output, i.e., output that is entirely or primarily comprised of alphanumeric text or simple graphics on a solid white background. As indicated previously, document applications may include word processing application programs, presentation application programs, messaging application programs, spreadsheet application programs, and the like.

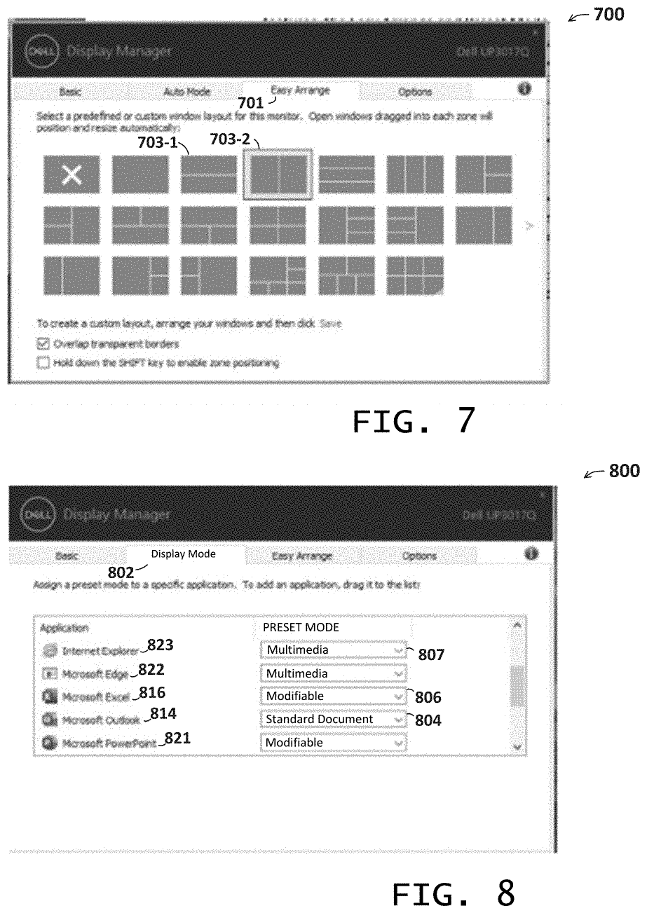

In embodiments of host 101 that include a display manager resource such as the display manager 113 illustrated in FIG. 1, information generated, maintained, or stored by the display manager may be used to facilitate the identification of target windows. FIG. 7 illustrates an exemplary EasyArrange page 701 for a display manager user interface 700. The illustrated EasyArrange page 701 presents the user with a number of predefined screen layouts 703-1, 703-2, and so forth. Each predefined screen layout 703 may define the pixel coordinates for each screen portion illustrated in the applicable layout. For example, the screen layout 702-2 may define the pixel coordinates for each of the two vertically arranged windows. Embodiments that employ a display manager with such a feature may leverage the pixel coordinate information maintained by the display manager and use this information to identify windows that might be suitable and eligible for background modification.

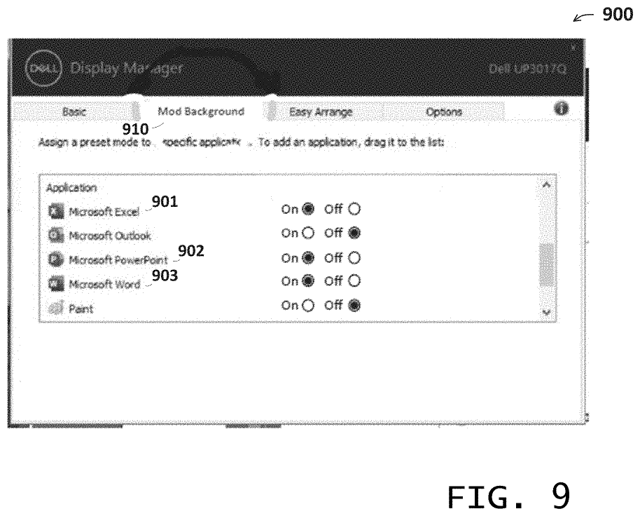

Referring to FIG. 8, an exemplary display manager user interface 800 includes a display mode page 802 that may further facilitate background modification techniques by enabling a user to associate one or more application programs with one of a limited number of preset display modes. The preset display modes may indicate application programs that have been assigned a preset display mode that is compatible with background modification described herein. Each preset display mode may be associated with a corresponding set of video and color processing configuration settings. In such embodiments, the preset display modes may indicate, as one example, a type or quality of the display output typically generated by the application program. In some embodiments, the preset display modes recognized or supported by the display manager may include one or more preset display modes specific to document applications. The preset display modes for a document application may include, as non-limiting examples, a modifiable document mode identifying a document application for which background modification as disclosed herein is to be performed as well as a standard document mode to indicate a document application for which background modification has been disabled. The display mode page 802 depicted in FIG. 8 illustrates three preset display modes, including a standard document display mode 804, which has been associated with Microsoft Outlook application program 814 in FIG. 8, and a modifiable document mode 806, which has been associated with the Microsoft Excel application 816. The display mode page 802 of FIG. 8 further illustrates a multimedia mode display 807, which has been assigned to multiple application programs including the Microsoft PowerPoint application program 821, the Microsoft Edge application program 822, and the Internet Explorer program 823.

Referring to FIG. 9, an exemplary display manager user interface 900 may further include a background modification page 910 that enables users to easily identify which applications support background modification, which of those applications have enabled background modification and which applications have disabled the feature. In the illustrated example, the five listed applications support background modification and, of those, background modification is enabled for three of the applications, including the Microsoft Excel application 901, the Microsoft PowerPoint application 902, and the Microsoft Word application 903.

Returning to FIG. 4, after identifying one or more target windows in operation 410, the illustrated background modification method 400, performs window-to-pixel mapping operations 420 for each targeted window. The window-to-pixel mapping operations 420 illustrated in FIG. 4 include obtaining (operation 422) pixel coordinates corresponding to each targeted window. In at least some embodiments, window to pixel mapping is facilitated by communication between scaler 174 (FIG. 1) and display manager 113 (FIG. 1).

Display manager 113 may support a window placement feature for managing the screen locations of multiple open application windows. This feature may include functionality analogous to functionality included in the EasyArrange feature of the Dell Display Manager from Dell, Inc. When the window placement feature is enabled, the display manager 113 may store information indicating the pixel coordinates of one or more pre-defined application window spaces. In addition, each pre-defined application window space may be associated with a particular application such that, as an example, when the user opens a spreadsheet application program, display manager 113 coordinates the placement of the corresponding application window in accordance with settings defined in the window placement feature. Display manager 113 may communicate with the display device via a standard or predefined protocol for display device configuration including, as one example, the Monitor Control Command Set (MCCS) standard. MCCS uses binary codes, referred to as Virtual Control Panel (VCP) codes to indicate properties of a display device. In at least one embodiment, the scaler 174 may retrieve the pixel coordinates of a targeted window by reading a custom defined VCP code register.

In embodiments employing a scaler 174 that includes subzone support, the illustrated background modification method 400 may include mapping (operation 424) a pixel subzone recognized by scaler 174 to the pixel coordinates of the targeted window. In these embodiments, the background modification process could then determine (operation 442) whether the subzone qualifies for background modification based on any suitable criteria that the scaler may assess. As an example, if the scaler supports an ability to determine a percentage of white pixels, this functionality could be invoked to determine whether the percentage of white pixels exceeds a background modification threshold. If the background modification threshold is 80%, the determination of whether a pixel subzone qualifies for background modification could include a determination of whether the subzone comprises 80% or more white pixels.

If the pixel subzone satisfies the requirements for background modification, the illustrated background modification method 400 may modify (operation 444) the gray level for all white pixels in the pixel subzone and then determine (operation 446) whether background modification has been disabled. If background modification has not been disabled, i.e., remains enabled, then the illustrated method determines (operation 450) whether all of the targeted windows for the current image frame have been processed. If any targeted windows have not yet been processed, background modification method 400 proceeds (operation 452) to the next window and returns to operation 422, to repeat the process. If it is determined in operation 450 that all of the targeted windows have been processed, the illustrated background modification method 400 then obtains (operation 454) the next frame of pixel data and returns to operation 410 to identify the targeted windows in the next frame.

Although the present disclosure has been described in detail, it should be understood that various changes, substitutions, and alterations can be made hereto without departing from the spirit and the scope of the disclosure as defined by the appended claims.

What is claimed is:

1. An information handling system, comprising:
a host, wherein the host includes:
a central processing unit (CPU) to generate display information for one or more windows associated with one or more application programs; and
a graphics module to generate first pixel data corresponding to the display information; and
a display device, wherein the display device includes:
a display panel comprising a pixel array, wherein the pixel array comprises an array of pixels; and
a display controller to:
generate second pixel data corresponding to the first pixel data, wherein a format of the second pixel data is compatible with the display device; and
drive the display panel in accordance with the second pixel data to display the one or more windows;
wherein the display controller is configured to perform background modification operations, wherein the background modification operations include:
identifying a document window, wherein the document window comprises a subset of the pixel array associated with an application program displaying document output; and
responsive to determining that pixel data corresponding to the document window satisfies a background modification condition, changing pixel data for one or more background pixels in the document window, wherein a background pixel comprises a pixel associated with a first color.

2. The information handling system of claim 1, wherein the display device is an organic light emitting diode (OLED) display device.

3. The information handling system of claim 1, wherein identifying a document window includes communicating with a display management application maintaining window information indicative of pixel coordinates associated with each of the one or more windows.

4. The information handling system of claim 1, wherein identifying a document window includes identifying pixel coordinates of a document application and mapping the pixel coordinates to one or more pixel array subzones defined by the display controller.

5. The information handling system of claim 1, wherein changing pixel data comprises reducing a luminous intensity of a background pickle.

6. The information handling system of claim 1, wherein the background modification condition comprises a percentage of pixels having the first color exceeds a threshold percentage.

7. The information handling system of claim 1, further comprising determining a background color, wherein determining the background color includes determining a minimum luminous intensity required to achieve a threshold minimum contrast ratio.

8. The information handling system of claim 7, wherein determining the minimum luminous intensity comprises accessing information indicative of at least two points of a gamma curve characteristic of the display panel.

9. A display device, wherein the display device includes:
a display panel comprising a pixel array, wherein the pixel array comprises an array of pixels; and
a display controller to:
generate second pixel data corresponding to first pixel data received from a host, wherein a format of the second pixel data is compatible with the display device; and
drive the display panel in accordance with the second pixel data to display information generated by the host for one or more windows associated with one or more application programs;
wherein the display controller is configured to perform background modification operations, wherein the background modification operations include:
identifying a document window, wherein the document window comprises a subset of the pixel array associated with an application program displaying document output; and
responsive to determining that pixel data associated with the document window satisfies a background modification condition, changing pixel data for one or more background pixels in the document window, wherein a background pixel comprises a pixel associated with a first color.

10. The display device of claim 9, wherein the display device is an organic light emitting diode (OLED) display device.

11. The display device of claim 9, wherein identifying a document window includes identifying includes communicating with a display management application maintaining window information indicative of pixel coordinates associated with each of the one or more windows.

12. The display device of claim 9,. wherein identifying a document window includes identifying pixel coordinates of a document application and mapping the pixel coordinates to one or more pixel array subzones defined by the display controller.

13. The display device of claim 9, wherein changing pixel data comprises reducing a luminous intensity.

14. The display device of claim 9, wherein the background modification condition comprises a percentage of pixels having the first color exceeds a threshold percentage.

15. The display device of claim 9, wherein document output comprises alphanumeric text on a solid white background.

16. The display device of claim 9, further comprising determining a background color, wherein determining the background color includes determining a minimum luminous intensity required to achieve a threshold minimum contrast ratio.

17. The display device of claim 9, wherein determining the minimum luminous intensity comprises accessing information indicative of at least two points of a gamma curve characteristic of the display panel,

18. The display device of claim 9, wherein identifying a document includes mapping one or more subzones of the pixel array.

19. The display device of claim 9, further comprising: determining a background color, wherein determining a background color includes determining a luminous intensity corresponding to a minimum luminous intensity satisfying a contrast ratio threshold.

20. A method of displaying information with a display device, wherein the method includes:
generating second pixel data corresponding to first pixel data received from a host, wherein a format of the second pixel data is compatible with the display device; and
drive the display panel in accordance with the second pixel data to display information generated by the host for one or more windows associated with one or more application programs; and
performing background modification operations, wherein the background modification operations include:
identifying a document window, wherein the document window comprises a subset of the pixel array associated with an application program displaying document output; and
responsive to determining that pixel data associated with the document window satisfies a background modification condition, changing pixel data for one or more background pixels in the document window, wherein a background pixel comprises a pixel associated with a first color.
